(19) United States
(12) Patent Application Publication
(10) Pub. No.: US 2008/0223093 A1
(43) Pub. Date: Sep. 18, 2008

(54) Self Adjusting Lock System And Method

(76) Inventor: Haim Amir, Ramat Hasharon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/685,789

(22) Filed: Mar. 14, 2007

(51) Int. Cl. E05B 49/02

(52) U.S. Cl. 70/283.1; 70/367; 70/434

(57) ABSTRACT

A self adjusting lock system including: a lock cylinder having a direction of elongation defining an axial direction for the system and having a first and a second end; a rotatable first cylindrical plug in the lock cylinder, the first plug having an axially extending key slot from the first end of the lock cylinder; a rotatable second cylindrical plug in the lock cylinder, the second plug substantially coaxial to the first cylindrical plug; a bolt which is retractable substantially perpendicularly to the axial direction by rotation of each of the first plug and the second plug; and a control and rotation unit adapted to rotate the second plug, including: a power source, a processor; a motor; a current sensor adapted to sense motor current; and a clock adapted to measure time; wherein the control and rotation unit is adapted to sense motor current over time and to adjust operation of the lock system dependent on the sensed motor current over time.

### FIELD AND BACKGROUND OF THE INVENTION

The present invention relates to a self adjusting lock system and, in particular, it concerns a self adjusting retrofittable system that can be operated to bolt and unbolt a lock, such as used in doors, and one which may also be operated mechanically in case of power failure.

In a conventional mechanical cylinder lock, when an appropriate matching key is inserted into the cylinder lock, the key serves to mechanically align tumbler pins (“unlocked” or “opened” state), allowing the cylindrical plug to be rotated freely to retract a bolt which is typically mechanically connected the cylindrical plug and is driven by the rotated cylindrical plug. Retraction of the bolt is typically referred to as “unbolting” the lock. Conversely, when the cylindrical plug is rotated (usually in a direction opposite that used for unbolting) and the bolt is extended in such a way as to inhibit movement of a door or window, etc. the action is referred to as “bolting” the lock. Following bolting, the key is typically withdrawn from the key slot, the tumbler pins are not aligned, which inhibits free rotation of the cylindrical plug, and the lock is then in a “locked” or “closed” state.

In a conventional mechanical cylinder lock, when an appropriate matching key is inserted into the cylinder lock, the key serves to mechanically align tumbler pins, and thereby allowing the cylindrical plug to be rotated freely to open the lock. Referring now to FIGS. 1A and 1B, which are representations of a prior art cylinder lock 10, with a key 12 inserted into the cylinder lock, and a door lock 15. Door lock 15 includes, inter alia, a shaped slot 16 for receiving cylinder lock 10 and a door lock hole 16 through which a bolt (not shown) is inserted to secure the cylinder lock inside a door. Typically, door lock 15 is inserted into a hollowed-out edge of the door (not shown) and cylinder lock 10 is inserted through prepared holes in the door (not shown in the figure) and perpendicularly into and through shaped slot 16, substantially along axis 18. Door lock further comprises a bolt 19. Typically, cylinder lock 10, when unlocked, serves to translate bolt 19 out of and back into the cylinder lock, respectively bolting and unbolting the lock. Typically, other cylinder locks having a cross-sectional profile and length substantially matching cylinder lock 10 may be replaced or retrofitted instead of cylinder lock 10. Typical names/manufacturers of such cylinder locks include, but are not limited to: Euro Cylinders; Oval Cylinders; Asec 6-pin Euro profile; and Chubb M3. Overall lengths of such cylinders typically vary from approximately 70-95 mm.

Reference is now made to FIGS. 2A and 2B, which are cross sectional side views A-A of the cylinder lock shown in FIG. 1A. The cylinder lock has a body housing 20, which is bored from one end to the other end and a cylindrical plug 22, which is fitted into the bore, and which may be rotated, as described hereinbelow. A set hole 23 is located approximately in the middle of cylinder lock 10 to typically receive a threaded bolt (not shown in the figure) which is inserted into lock hole 16, to secure the cylinder lock within door lock 15, as described hereinabove in FIG. 1B. Cylindrical plug 22 has a key slot 25 formed axially in cylindrical plug. Key 12 is inserted into slot 25. A pin-tumbler set 30 is located in body housing 20 and in cylindrical plug 22 to serve to lock and unlock rotational movement of cylindrical plug 22. Cylindrical plug 22 and a second cylindrical plug 31 may be mechanically coupled and uncoupled to a rotating tongue 35 by means of a selector mechanism (not shown in the figure), which allows either of the two cylindrical plugs to rotate the rotating tongue, which in turn serves to move the bolt of the door lock (refer to FIG. 1B). The cylinder lock shown in FIGS. 2A and 2B is called a “blind cylinder”, in that a key can be inserted into only one side of the lock. However, cylinder lock 10 may also comprise pin-tumbler sets in respective cylindrical plugs at both ends.

FIG. 2B, which is a detailed view of FIG. 2A, shows in greater detail pin-tumbler set 30. Pin-tumbler set 30 includes tumbler pins 32 and driver pins 34, both of which are constrained to move generally perpendicularly to key 12. Springs 33 typically serve to preload the driver pins and the tumbler pins, displacing them towards slot 25, thereby advancing part of one or more of driver pins 34 into cylindrical plug 22 through openings in the plug (not shown in the figure) and thereby locking rotation of cylindrical plug 22 when no key is present in the slot. Typically, key 12 is formed to fit the pattern and respective lengths of tumbler pins 32. When key 12 is fully inserted into slot 25, the key presses tumbler pins 32 and driver pins 34 against springs 33, alignedly inserting driver pins 34 into body housing 20, and thereby enables rotation of the cylindrical plug. Whereas key 12 is shown inserted, with its wider traverse edge contacting the tumbler pins, another inserted orientation of key 12 may include its thinner traverse edge contacting the tumbler pins. Also, one or more additional sets of collinearly arranged tumbler pins (not shown) may be present, in the case of a master key, which is used to lock and unlock a number of such specially configured cylinder locks.

A number of prior art electronic or combination electrical/mechanical lock systems allow a user to open a locked cylinder in a number of ways. In U.S. Pat. No. 3,889,501 by Fort, whose disclosure is incorporated herein by reference, a combination electrical and mechanical system is described. The system includes a lock having a fixed lock cylinder and a rotatable key slug. A first solenoid is employed in the current system to drive a lock pin, which is normally extended to lock the key slug. Upon insertion of an appropriately aperture-encoded key, light sources and detectors mounted in the lock are used in concert with appropriate circuitry to operate to the first solenoid to unlock key slug. A second solenoid is operable, in response to an electrical power failure, to extend a bolt pin. When the bolt pin is extended a proper mechanical key is inserted and rotated, extension of the lock pin is prevented. A proper mechanical key can be inserted to move a plurality of spring loaded pin tumblers in the lock to enable rotation of the key slug during an electrical power failure.

A conventional lock may be repeatedly bolted and unbolted over a relatively long period of time with no noticeable degradation in operation. When necessary, additional manual effort in moving elements of the lock, such as the cylindrical plug and elements attached to the plug, is sufficient to overcome any degradation due to mechanical wear, friction, thermal changes, and dirt—among other causes of degradation. However, in an electrically operated lock (especially one having a motor with limited torque or having a limited power source, such as a battery-powered motor) degradation in lock operation due to any of the causes noted hereinabove could yield a failure in electrical lock operation. To avoid or deal with such cases, it is very useful for an electrically operated lock to have the capability to self adjust and thereby ensure smooth lock operation or to signal a condition where lock failure is impending or occurs. In the description and claims hereinbelow, the term “self adjust” refers to any method of exclusively using the characteristics of the electrical motor or motors operating the lock to directly: effect changes in lock operation; signal an impending lock failure condition; and signal a condition of lock failure.

A rotary locking mechanism is disclosed by Santamalta, in US Patent Application Publication no. 2006/0048552A1, whose disclosure is incorporated herein by reference. The locking mechanism is preferably intended for lock cylinders and includes an electric motor, a locking bolt, an inertial rotating mechanism which converts the rotation of the motor into a rectilinear movement along the axis of the locking bolt, an elastic accumulator (such as a spring) which is arranged in opposition to the backward retraction travel of the locking bolt and a rectilinear guide mechanism for the working extraction/retraction travel of the locking bolt. Interaction of the inertial rotating mechanism and the elastic accumulator allow a motor to be used having non critical mechanical characteristics, ensuing cost savings when choosing the motor.

Fonea, in U.S. Pat. No. 6,147,622, whose disclosure is incorporated herein by reference, discloses an electronic lock system which is also manually operable to drive a lock cylinder to move a lock mechanism which includes at least one bolt. The system includes a bidirectional motor engagable with the lock cylinder At least one sensor in the lock system is used in conjunction with an angular measurement device and/or stepper motor feedback to provide a level of lock self diagnostics and self testing. The system may also be operated in a mechanical manner. Additional features of the lock system, not related to the capabilities noted hereinabove are also disclosed.

While the prior art includes an array of combination electrical/mechanical lock systems of varying complexity and systems that employ some adjustment based on mechanical feedback, there is a need for an electronic or combination electrical/mechanical system that has the capability to self adjust the lock over time, based on the characteristics of the electrical motor or motors operating the lock and a system which can easily be retrofitted to an existing lock installation. The system should be remotely operated to unbolt and bolt the lock and to allow the same operations to be performed in a conventional manual manner in case of an electrical power failure. Furthermore, such a system could be integrated with the capabilities of electric and manual locking and unlocking of the lock.

### SUMMARY OF THE INVENTION

The present invention is a self adjusting lock system that can be operated to bolt and unbolt a lock, which is retrofittable to a conventional lock system and one which may be operated in a conventional manner upon power failure. Furthermore, such a system may include capabilities of electrical and manual locking and unlocking.

According to the teachings of the present invention there is provided a self adjusting lock system including: a lock cylinder having a direction of elongation defining an axial direction for the system and having a first and a second end; a rotatable first cylindrical plug in the lock cylinder, the first plug having an axially extending key slot from the first end of the lock cylinder; a rotatable second cylindrical plug in the lock cylinder, the second plug substantially coaxial to the first cylindrical plug; a bolt which is retractable substantially perpendicularly to the axial direction by rotation of each of the first plug and the second plug; and a control and rotation unit adapted to rotate the second plug, including: a power source, a processor; a motor; a current sensor adapted to sense motor current; and a clock adapted to measure time; wherein the control and rotation unit is adapted to sense motor current over time and to adjust operation of the lock system dependent on the sensed motor current over time.

Preferably, the control and rotation unit further includes a control module adapted to receive and to transmit signals and the processor is adapted to process and store data. Most preferably, the control and rotation unit is adapted to store data indicative of sensed motor current versus time from operation of the lock system. Typically, the control and rotation unit is adapted to perform an initial training operation to create a first current-versus-time profile, representing a plurality of events in the operation of the lock system, while performing at least one of: actuating the motor to rotate the second cylindrical plug from a bolted state to an unbolted state; and actuating the motor to rotate the second cylindrical plug from an unbolted state to a bolted state. Most typically, the control and rotation unit is adapted to perform at least one additional training operation to create at least one subsequent current-versus-time profile, representing a plurality of events in the operation of the lock system, while actuating the motor to rotate the second cylindrical plug from a bolted state to an unbolted state and actuating the motor to rotate the second cylindrical plug from an unbolted state to a bolted state. Most preferably, the initial current-versus-time profile is obtained from data. Typically, the subsequent current-versus-time profile is obtained from data.

Preferably, the control and rotational unit is adapted to mathematically operate upon the initial and the at least one subsequent current-versus-time profile to create and store a comparative current-versus-time profile. Most preferably, the control and rotational unit is further adapted to calculate and store an electrical current threshold value and a time interval threshold value for respective events of the comparative current-versus-time profile based on data from corresponding respective events of the initial and subsequent current-versus-time profiles. Typically, the electrical current threshold and time interval threshold values represent respective upper limit values corresponding to respective events. Most typically, the control and rotation unit is further adapted to compare sensed motor current and measured times of motor operation against the stored comparative current-versus-time profile and to determine whether instant sensed current and measured times do not exceed values of the comparative current-versus-time profile.

Preferably, the control and rotation unit is adapted to set a warning flag when at least one of the instant sensed current and measured times exceed values of the comparative current-versus-time profile. Most preferably, the control and rotation unit is further adapted to compare sensed motor current and measured times of motor operation against the stored respective threshold values and to set an error flag when at least one respective threshold value is exceeded.

Preferably, the control and rotation unit is further adapted to self adjust the lock system when at least one threshold value is exceeded, the self-adjustment being at least one chosen from the list including: stopping motor operation; reversing motor operation; and recording the sensed motor current and time values. Most preferably, the control and rotation unit is adapted to command rotation of the motor for a predetermined time to determine whether sensed current values are excessive and to stop motor operation for lock system servicing if sensed current values be excessive. Typically, the control and rotation until is adapted to recalculate comparative current-versus-time profile and threshold values are recalculated as part of the self adjustment.

Preferably, lock system is retrofittable in place of a conventional lock cylinder. Most preferably, the control and rotation unit further comprises a manual drive module adapted to disengage the motor and to enable manual rotation of the second cylindrical plug.

Preferably, the control and rotation unit is supported from the second end of the lock cylinder. Most preferably, a selector mechanism, located between the first cylindrical plug and the second cylindrical plug, is adapted to enable non-simultaneous rotation of the second and the first cylindrical plug. Typically, the selector mechanism is configured to primarily enable rotation of the second cylindrical plug. Most typically, rotation of the first cylindrical plug is enabled when a key is inserted into the key slot, the key acting to operate the selector mechanism. Typically, rotation of the first cylindrical plug is enabled by a mechanism internal to the lock system.

According to the teachings of the present invention there is further provided a method of operating a self-adjusting lock system comprising the steps of: taking a lock cylinder having a direction of elongation defining an axial direction for the system and having a first and a second end; configuring a rotatable first cylindrical plug in the lock cylinder, the first plug having an axially extending key slot from the first end of the lock cylinder; positioning a rotatable second cylindrical plug in the lock cylinder, the second plug substantially coaxial to the first cylindrical plug; locating a bolt which is retractable substantially perpendicularly to the axial direction by rotation of each of the first plug and the second plug; and configuring a control and rotation unit to rotate the second plug, including: a processor; a motor; a current sensor to sense motor current; and a clock to measure time; wherein the control and rotation senses motor current over time and adjusts the lock system dependent on the sensed motor current over time.

### BRIEF DESCRIPTION OF THE DRAWINGS

The invention is herein described, by way of example only, with reference to the accompanying drawings, wherein:

FIGS. 1A and 1B are representations of a prior art cylinder lock and a door lock, respectively;

FIGS. 2A and 2B are cross sectional side views of the cylinder lock shown in FIGS. 1A and 1B;

FIGS. 3A and 3B are an illustrative diagram and a sectional diagram, respectively, of a self-adjusting lock system in accordance with an embodiment of the present invention;

FIG. 4 is an exemplary current-versus-time profile plot in accordance with an embodiment of the current invention; and

FIG. 5 is the current-versus-time profile plot of FIG. 4 showing an occurrence of the motor current value I₃ exceeding a current-threshold value Th-I₃.

### DESCRIPTION OF PREFERRED EMBODIMENTS

The present invention includes a lock apparatus that can be operated to bolt and unbolt a lock, such as used in doors, and one which may also be operated mechanically in case of power failure.

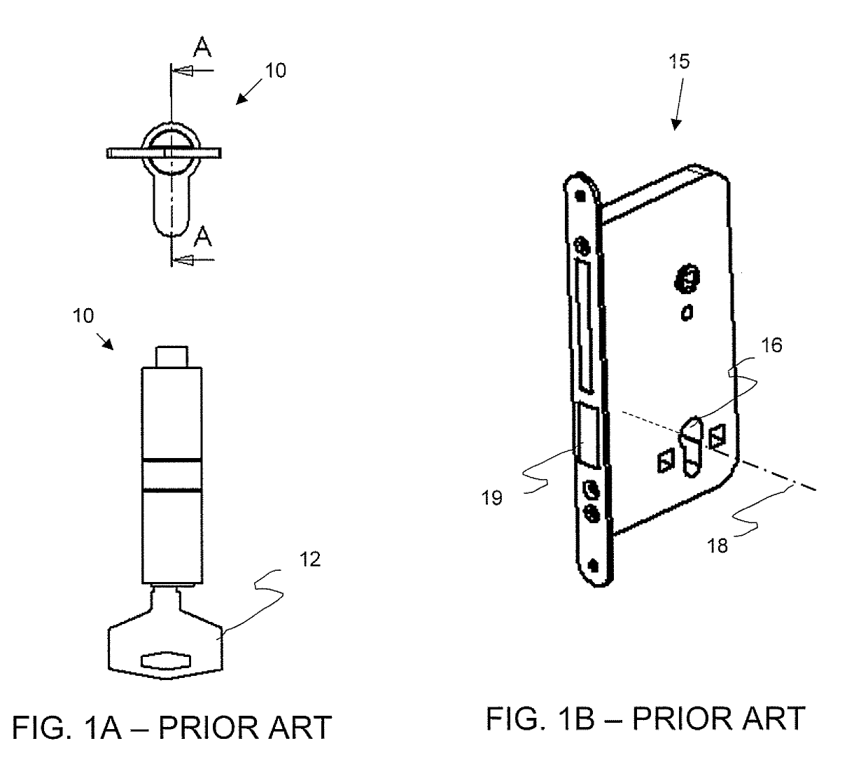

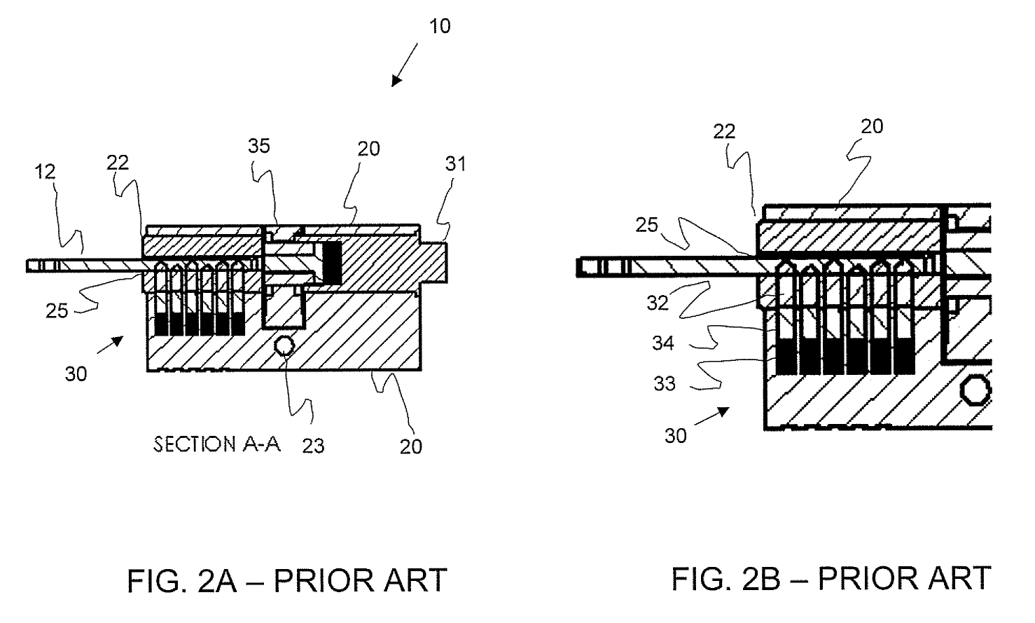

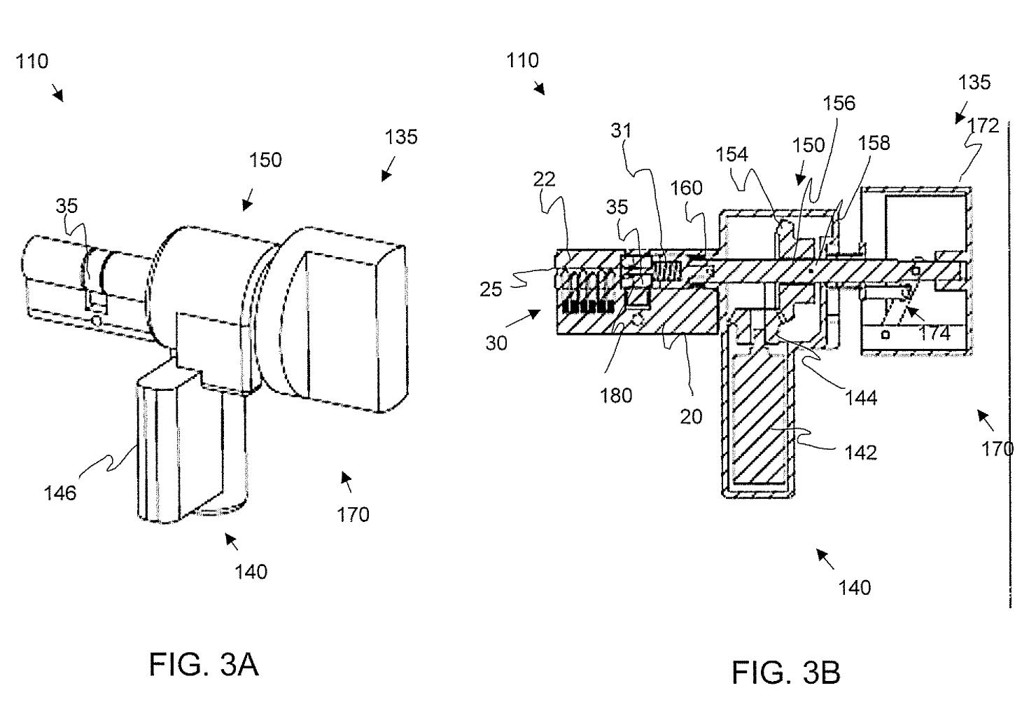

Reference is now made to FIGS. 3A and 3B, which are, respectively, an illustrative diagram and a sectional diagram of a self-adjusting lock system 110 in accordance with an embodiment of the present invention. Apart from differences described below, self-adjusting lock system 110 is generally similar to operation of cylinder lock 10 as shown in FIGS. 2A and 2B, so that elements indicated by the same reference numerals are generally identical in configuration and operation. Embodiments of the current invention disclosed hereinbelow are directed to be generally replaceable to cylinder lock 10 and/or retrofittable to cylinder lock 10 in door lock 15 shown in FIGS. 1A, 1B, 2A, and 2B. Specifically, self-adjusting lock system 110 has a “blind cylinder”, in that a key can be inserted into only one side of the lock system.

In one embodiment of the current invention, the side of the lock system in which a key is inserted is outside a door and/or towards an unsecured area, whereas the blind side of the lock system is inside a door and/or towards a secured area. This orientation of the lock system would typically allow a person in the secured area and/or inside the door to unbolt the door without a key, whereas a key and/or a remote control unit would be necessary to open and unbolt the lock system from outside the door and/or in the unsecured area. Operation of the lock system 110 is further described hereinbelow.

Lock system 110 has a blind plug rotation module 135, which includes a motor and power module 140, gearing module 150, and manual drive module 170. Blind plug rotation module 135 is configured substantially coaxially with the axis of rotation of blind plug 31 and motor and power module 140 is configured substantially normal to axis of rotation of blind plug 31. Furthermore, motor and power module 140 is configured substantially parallel and flush with the door surface (not shown in the figure). Motor and power module 140, is configured to provide rotation displacement to the gearing module to unbolt the lock system, as describe hereinbelow. In an embodiment of the current invention, the motor and power module includes electronic components (not shown in the figures) to enable command and telemetry information to be exchanged with it and a remote controller which may be wired and/or which may be in the form of a cellular telephone, key fob, computer, or any device that affording wireless control. Manual drive module 170 is also configured to provide rotation to unbolt the lock system, as described hereinbelow.

Motor and power module 140 includes an electric or electronic rotational drive motor 142 which drives a motor beveled gear 144. A power source 146, which may be in the form of batteries or an electrical mains connection, may be located between motor 142 and the door surface, or the power source may be located to either side of the motor or, alternatively, with the motor between the power source and the door surface. When commanded to drive, the drive motor turns motor beveled gear 144, which is engaged substantially normally with a bolting beveled gear 154. Drive shaft 156 is configured substantially coaxially with blind plug 31 and the drive shaft runs through the center of bolting beveled gear 154. The bolting beveled gear is fixed to the drive shaft by means of pin 158, as shown. Blind plug 31 is shaped to fit into drive shaft 156 as shown, and a pin-in-slot configuration 160 enables drive shaft 156 to rotate the blind while enabling the drive shaft to be translated away from the blind plug. The motor and power module also includes (not indicated in the figures): a processor which can store data, a current sensor to sense motor current; and a clock to measure time. The processor, current sensor, and clock are further discussed hereinbelow.

Manual drive module 170 includes drive knob 172 which fits over and is mechanically connected to the end of drive shaft 156 by linkage 174. Linkage 174 is configured to allow the drive shaft to be translated away from the blind plug by pressing drive knob 172 towards the blind plug. When the drive shaft is translated away from the blind plug sufficiently, bolting beveled gear 154 is disengaged from motor beveled gear 144, thereby enabling manual rotation of the blind plug by drive shaft 156 by rotation of drive knob 172. Linkage 174 may have a bias mechanism, such as a spring (not shown in the figure) to bias the drive shaft so that bolting beveled gear 154 is normally engaged with motor beveled gear. Such a bias mechanism allows the lock system to be in a state where the motor normally operates to bolt and unbolt the lock system even if the drive knob were recently used.

A selector mechanism 180 is positioned between the blind plug and cylindrical plug 22. The selector mechanism is further described hereinbelow.

The inventor of the current patent application, in U.S. patent application Ser. No. 11/469865, referred hereinbelow as '865 and whose disclosure is incorporated herein by reference, discloses various features, configurations, and methods of opening a lock cylinder with and without a key, including inter alia: electronic, remote, and manual operation of the lock cylinder. A cylindrical plug rotational handle is further disclosed in '865, which enables a cylindrical plug located at the key slot side of the lock cylinder to be manually rotated when the lock cylinder is unlocked without a key.

In addition, '865 discloses the incorporation of a selector mechanism generally identical in configuration and operation to selector mechanism 180 in the current FIG. 3B. The selector mechanism taught in '865 enables selective opening and rotation of the lock cylinder with a key or rotation of the cylinder from the blind side of the cylinder when no key is present, as shown in FIGS. 9A-C and 10A and B in '865 and described therein. Embodiments of the current invention may include features, configurations, and methods noted hereinabove as well as others disclosed in '865 to enhance the lock system operation, specifically in opening and closing the lock and in rotating cylindrical plug 22 and blind plug 31, in conjunction with bolting and unbolting the lock system, as described hereinabove.

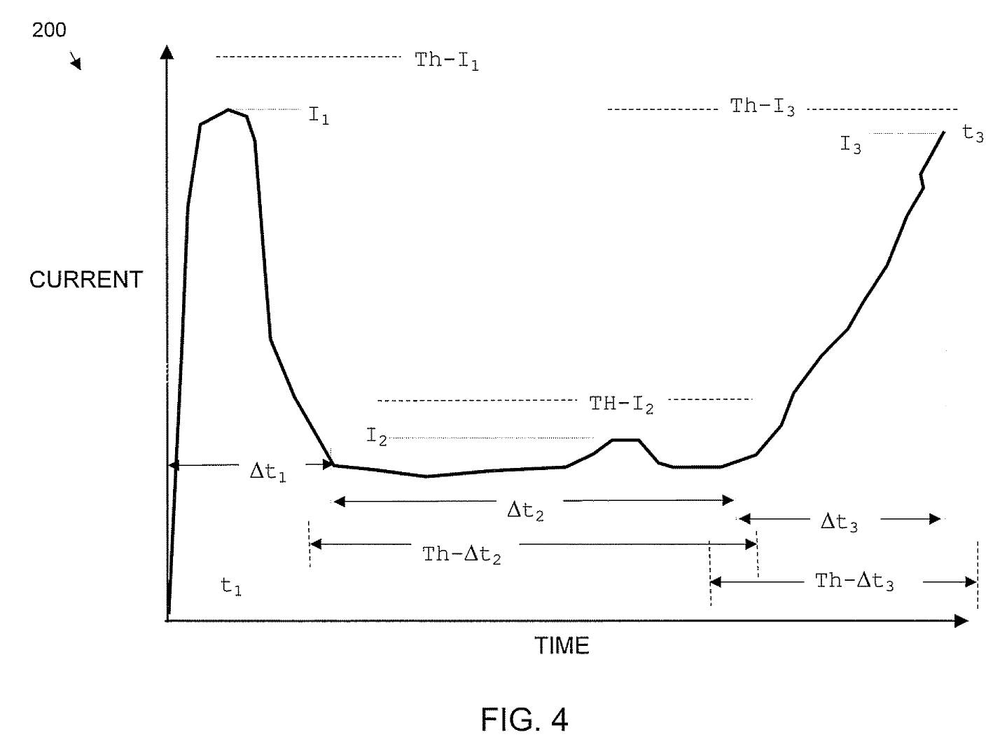

Reference is now made to FIG. 4, which is an exemplary current-versus-time (I versus t) profile plot 200, in accordance with an embodiment of the current invention. Although numerical values of I and t are not indicated in the current-versus-time (I versus t) profile plot 200 due to the very wide variation of motor and lock system characteristics, approximate typical representative ranges of current and time values could be on the order of milliamps to thousands of milliamps for current and on the order of tens to thousands of milliseconds for time. Embodiments of the current invention employing smaller and larger scaled lock systems would have different current and time characteristics, mutatis mutandis.

When rotational drive motor 142 (refer to FIG. 3B) is commanded to bolt or unbolt the lock system, the current sensor and the clock interact with the processor to create a current-versus-time profile plot 200. The current-versus-time profile represents a series of events in the operation of the lock system, as described hereinbelow. In considering the motor operation for unbolting the lock system from a completely bolted position, the motor is commanded at time t=0 and current=0. As is characteristic for most electric motors, the current increases rapidly even before the motor begins to turn. A maximum current value I₁ is obtained at time t₁, for example, as the motor turns, backlash in the gears and friction of the blind plug 31 are overcome, and retraction of the bolt (see FIG. 1B) is initiated. The motor current typically continues to drop as the bolt continues to move. After a time interval designated Δt₁, an initial portion of the lock system unbolting process is complete, as motor current ceases to drop quickly. Another time interval, designated Δt₂, follows wherein motor current is nearly constant over time, below a local maximum value of I₂, Time interval Δt₂ could correspond, for example, to smooth movement of the bolt, as retraction proceeds. Another time interval Δt₃, follows wherein motor current begins to rise rapidly to a value of I₃ at time t₃. Time interval Δt₃ could correspond, for example, to the bolt being presently fully retracted and an increase in gearing backlash. At the end of time interval Δt₃, the lock system is in a fully unbolted state and the motor is commanded to stop.

Knowing electromechanical characteristics of the rotational drive motor and mechanical characteristics of the gears and other mechanical components of the lock system, the current-versus-time profile may be used to give an indication of system performance and to furthermore enable adjustments to the lock system, as described hereinbelow. One way to develop such knowledge, for example, is to initially command the motor to unbolt the bolted lock system. Initial unbolting of the lock system may be performed, for example, after the lock system is initially installed or following some maintenance operation which could impact the lock system operation. An initial current-versus-time profile, similar to the current-versus-time profile shown in FIG. 4 is then recorded. Additional, subsequent unbolting current-versus-time profiles may be generated and stored, in a similar manner. Statistical techniques may be used as know in the art to operate upon the initial and subsequent current-versus-time profiles to determine typical mean current values for I₁, I₂, and I₃ and other current values and for determining corresponding mean time values and mean Δt values of a comparative current-versus-time profile—which has an appearance similar to current-versus-time profile plot 200. Other ways to obtain the comparative current-versus-time profile include: mathematically modeling system performance to calculate the profile; and combining both mathematical models with one or more physically run unbolting operations. The comparative current-versus-time profile is stored and it is used to compare against instantaneously-measured current-versus-time profile information from subsequent operation of the lock system.

Because the comparative current-versus-time profile represents a statistical sample and because the sample reflects a level of uncertainty, tolerance or threshold values for current values, time, and Δt values (as described above) are calculated or are set to reflect the level of uncertainty. Threshold values can serve as “upper limit” values in a similar fashion as “upper control limits” are applied in statistical process control in many manufacturing industries. This means, for example, that when the lock system is operated and when instant current-versus-time performance is monitored against the comparative current-versus-time profile, operation of the lock system continues even though a desired mean value is exceeded, so long as the corresponding threshold value is not exceeded. In the case of the comparative current-versus-time profile, values indicated in FIG. 4, such as Th-I₁, TH-I₂, TH-I₃ etc, represent thresholds of current values and Th-Δt₁, Th-Δt₂, and Th-Δt₃ represent thresholds for corresponding time interval values. Thresholds may be determined in a number of ways, including: calculating statistical variations of representative means of current and time values; applying a mathematical function (the simplest of which would be to add a constant relative value, such as adding 10%, to the mean value); or a combination of statistical and mathematical function techniques.

The current-versus-time profiles described hereinabove relate to an unbolting operation; however one skilled in the art will understand that a current-versus-time profile, a comparative current-versus-time profile, and corresponding threshold values can similarly be developed for an unbolting operation. In this way, bolting and unbolting operations for the lock system can be completely characterized with stored comparative current-versus-time profiles.

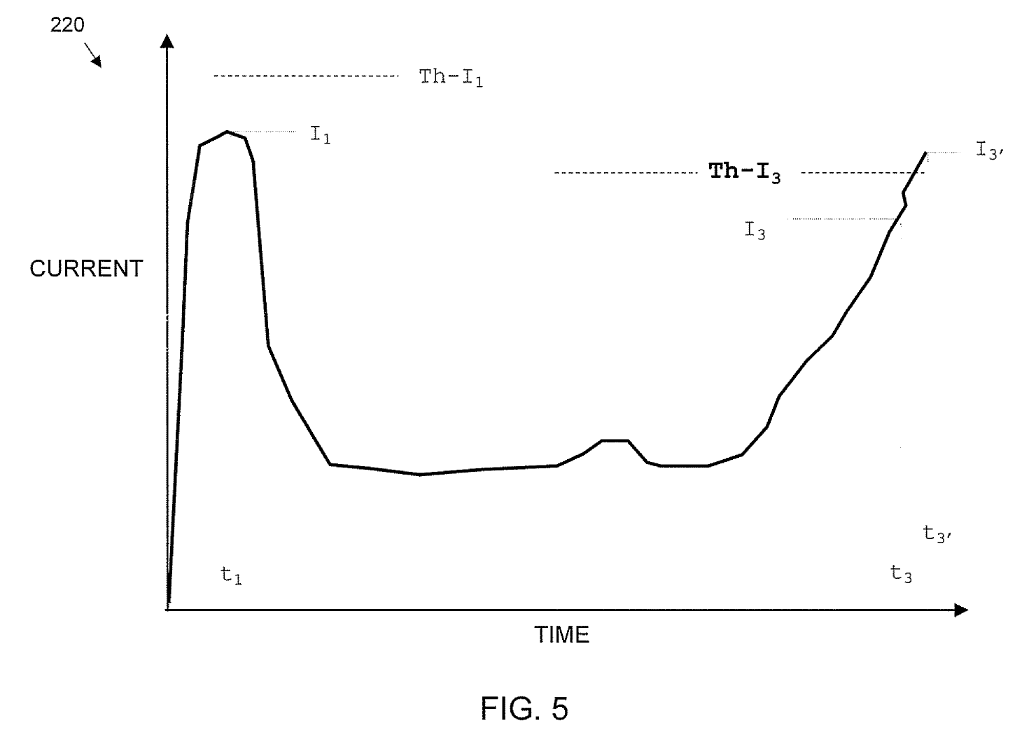

Reference is now made to FIG. 5, which is a comparative current-versus-time profile plot 220 for an unbolting operation showing an occurrence of the motor current value I_{3′} exceeding a current-threshold value Th-I₃ in accordance with and embodiment of the present invention. Apart from differences described below, current-versus-time profile plot 220 is generally similar to current-versus-time profile plot 200 as shown in FIG. 4, so that elements indicated by the notations in the figures are generally identical in meaning and operation. As noted hereinabove, comparative current-versus-time profiles and thresholds may be developed for bolting and unbolting operations, so that the following discussion applies for a bolting as well an unbolting operation, mutatis mutandis.

In an embodiment of the current invention, as the lock system is unbolted, motor current is monitored versus time and monitored current and time values are compared with the unbolted comparative current-versus-time profile stored in the system, as described hereinabove. When it is sensed that an instant current or time value exceeds the corresponding comparative current-versus-time profile, a warning flag or warning condition may be set, but no other action is taken by the system. Such an occurrence could be representative, for example, of a momentary increase in friction or some other spurious, short-lived problem of the lock system.

However, when it is determined, for example, that an instant current value exceeds the corresponding threshold value of the comparative current-versus-time profile, an occurrence which could represent a serious problem or failure of the lock system, the system will signal an error condition (i.e. setting an error flag), which may be local to the lock system itself and/or to a remote location. In addition, the system may take one or more of the following exemplary actions:
1. Stop the drive motor;
2. Reverse the direction of the drive motor; and
3. Record I_{3′} and its corresponding time value t_{3′}.

In addition to the actions listed above, embodiments of the current invention can include the processor automatically commanding the drive motor to rotate for a predetermined short time to determine if current values are again excessive. If current values are determined to be not excessive, then the system is allowed to continue operation. The processor may then recalculate the comparative current-versus-time profile and threshold Th-I₃, as well as threshold Th-Δt₃ (not indicated in the current figure). Additionally or alternatively, the lock system may automatically perform or be commanded to perform a complete unbolting operation and/or additional operations, such as downloading current-versus-time profile data, to retrain and/or to recalculate the comparative current-versus-time profile and respective threshold values.

If current values are still excessive, then the motor is stopped and an error condition is signaled. At this point, the lock system may be partially or completely inoperative until, for example, an obstruction is removed or a repair is made to the system, which may be followed by operations to recalculate the comparative current-versus-time profile and thresholds as described hereinabove.

The process of employing the processor, current sensor, and clock and controlling the drive motor and recalculating the comparative current-versus-time profile and one or more respective thresholds is a self-adjustment of the lock system operation. Other similar adjustments of the lock system may be initiated, for example, by data being transferred to the lock system, serving to change the comparative current-versus-time profile and one or more respective thresholds. As noted hereinabove, operation and calculation of current-versus-time profiles applies for bolting and for unbolting operations.

Whereas the embodiments of the current invention are described herein using a rotational drive motor and gearing, the principle of operating and adjusting operation of the lock system according to current-versus-time behavior of any drive system, such as but not limited to a linear motor, or any other type of motor, with our without gearing.

It will be appreciated that the above descriptions are intended only to serve as examples, and that many other embodiments are possible within the scope of the present invention as defined in the appended claims.

What is claimed is:

1. A self adjusting lock system comprising:
a lock cylinder having a direction of elongation defining an axial direction for the system and having a first and a second end;
a rotatable first cylindrical plug in the lock cylinder, the first plug having an axially extending key slot from the first end of the lock cylinder;
a rotatable second cylindrical plug in the lock cylinder, the second plug substantially coaxial to the first cylindrical plug;
a bolt which is retractable substantially perpendicularly to the axial direction by rotation of each of the first plug and the second plug; and
a control and rotation unit adapted to rotate the second plug, including: a power source, a processor; a motor; a current sensor adapted to sense motor current; and a clock adapted to measure time;
wherein the control and rotation unit is adapted to sense motor current over time and to adjust operation of the lock system dependent on the sensed motor current over time.

2. A lock system according to claim 1, wherein the control and rotation unit further includes a control module adapted to receive and to transmit signals and the processor is adapted to process and store data.

3. A lock system according to claim 2, wherein the control and rotation unit is adapted to store data indicative of sensed motor current versus time from operation of the lock system.

4. A lock system according to claim 3, wherein the control and rotation unit is adapted to perform an initial training operation to create a first current-versus-time profile, representing a plurality of events in the operation of the lock system, while performing at least one of: actuating the motor to rotate the second cylindrical plug from a bolted state to an unbolted state; and actuating the motor to rotate the second cylindrical plug from an unbolted state to a bolted state.

5. A lock system according to claim 4, wherein the control and rotation unit is adapted to perform at least one additional training operation to create at least one subsequent current-versus-time profile, representing a plurality of events in the operation of the lock system, while actuating the motor to rotate the second cylindrical plug from a bolted state to an unbolted state and actuating the motor to rotate the second cylindrical plug from an unbolted state to a bolted state.

6. A lock system according to claim 4 the initial current-versus-time profile is obtained from data.

7. A lock system according to claim 5, wherein the subsequent current-versus-time profile is obtained from data.

8. A lock system according to claim 7, wherein the control and rotational unit is adapted to mathematically operate upon the initial and the at least one subsequent current-versus-time profile to create and store a comparative current-versus-time profile.

9. A lock system according to claim 8, wherein the control and rotational unit is further adapted to calculate and store an electrical current threshold value and a time interval threshold value for respective events of the comparative current-versus-time profile based on data from corresponding respective events of the initial and subsequent current-versus-time profiles.

10. A lock system according to claim 9, wherein the electrical current threshold and time interval threshold values represent respective upper limit values corresponding to respective events.

11. A lock system according to claim 10, wherein the control and rotation unit is further adapted to compare sensed motor current and measured times of motor operation against the stored comparative current-versus-time profile and to determine whether instant sensed current and measured times do not exceed values of the comparative current-versus-time profile.

12. A lock system according to claim 11, wherein the control and rotation unit is adapted to set a warning flag when at least one of the instant sensed current and measured times exceed values of the comparative current-versus-time profile.

13. A lock system according to claim 11, wherein the control and rotation unit is further adapted to compare sensed motor current and measured times of motor operation against the stored respective threshold values and to set an error flag when at least one respective threshold value is exceeded.

14. A lock system according to claim 13, wherein the control and rotation unit is further adapted to self adjust the lock system when at least one threshold value is exceeded, the self-adjustment being at least one chosen from the list including: stopping motor operation; reversing motor operation; and recording the sensed motor current and time values.

15. A lock system according to claim 14, wherein the control and rotation unit is adapted to command rotation of the motor for a predetermined time to determine whether sensed current values are excessive and to stop motor operation for lock system servicing if sensed current values be excessive.

16. A lock system according to claim 15, wherein the control and rotation until is adapted to recalculate comparative current-versus-time profile and threshold values are recalculated as part of the self adjustment.

17. A lock system according to claim 1, wherein the lock system is retrofittable in place of a conventional lock cylinder.

18. A lock system according to claim 1, wherein the control and rotation unit further comprises a manual drive module adapted to disengage the motor and to enable manual rotation of the second cylindrical plug.

19. A lock system according to claim 1, wherein the control and rotation unit is supported from the second end of the lock cylinder.

20. A lock system according to claim 1, wherein a selector mechanism, located between the first cylindrical plug and the second cylindrical plug, is adapted to enable non-simultaneous rotation of the second and the first cylindrical plug.

21. The lock system of claim 20, wherein the selector mechanism is configured to primarily enable rotation of the second cylindrical plug.

22. The lock system of claim 21, wherein rotation of the first cylindrical plug is enabled when a key is inserted into the key slot, the key acting to operate the selector mechanism.

23. The lock system of claim 22, wherein rotation of the first cylindrical plug is enabled by a mechanism internal to the lock system.

24. A method of operating a self-adjusting lock system comprising the steps of:
taking a lock cylinder having a direction of elongation defining an axial direction for the system and having a first and a second end;
configuring a rotatable first cylindrical plug in the lock cylinder, the first plug having an axially extending key slot from the first end of the lock cylinder;
positioning a rotatable second cylindrical plug in the lock cylinder, the second plug substantially coaxial to the first cylindrical plug;
locating a bolt which is retractable substantially perpendicularly to the axial direction by rotation of each of the first plug and the second plug; and
configuring a control and rotation unit to rotate the second plug, including: a processor; a motor; a current sensor to sense motor current; and a clock to measure time;
wherein the control and rotation senses motor current over time and adjusts the lock system dependent on the sensed motor current over time.
